(19) United States
(12) Patent Application Publication
(10) Pub. No.: US 2001/0027414 A1
(43) Pub. Date: Oct. 4, 2001

(54) Advertisement providing system and advertising providing method

(76) Inventor: Tomihiko Azuma, Tokyo (JP)

Correspondence Address: McGuire Woods, 1750 Tysons Boulevard, Suite 1800, Tysons Corner, McLean, VA, 22102-4215, US

(21) Appl. No.: 09/803,926

(22) Filed: Mar. 13, 2001

(30) Foreign Application Priority Data
Mar. 31, 2000 (JP) 2000-096711

(51) Int. Cl. G06F 17/60

(52) U.S. Cl. 705/14

(57) ABSTRACT

A service providing site 10 transmits to a mobile telephone set 20 a sound advertisement data A convertible to a sound signal “a”. The mobile telephone set 20 receives the sound advertisement data A, converts the sound advertisement data A to the sound signal “a”, outputs the signal, and transmits an advertisement output acknowledgement signal B to the service providing site 10. The service providing site 10 receives the advertisement output acknowledgement signal B and starts to provide the service. Thus, by using a sound advertisement instead of an image advertisement, it is possible to assure to provide an advertisement even on the mobile telephone set 20 having a low resolution and a small display.

### BACKGROUND OF THE INVENTION

1. Field of the Invention

The present invention relates to an advertisement providing system and an advertising providing method for providing from a service providing site via a communication network to user terminals.

2. Description of the Related Art

Conventionally, most of the services provided on the internet are designed assuming that personal computers are used as the user terminals. A plurality of enterprises provide advertisements on home pages providing useful services which are considered to be accessed by a plenty of users. Most of the sites providing the services provide these services to the users without charging because they can get advertisement fees.

The advertisements provided by enterprises as sponsors include animation for attracting users' attention. Normally, a personal computer is provided with a display of a certain size and a high dissolution and the user can faithfully reproduce the advertisement shown on the home pages. A contract between an enterprise and a site providing a service is based on the assumption that contents of the advertisement are sure to reach users and attract attention of users.

However, this conventional art has a problem as follows.

The problem is that a user terminal that can be used by a user is limited to a personal computer provided with a display having a certain size and a high resolution. This is because the advertisements displayed on the sites providing services often include animation or still images for attracting users' visual attention. When a user is to faithfully reproduce an advertisement offered by a sponsor on a user terminal, a display having a certain size and a high resolution is indispensable. Mobile phones rapidly spread recently have a display very small and a low resolution, disabling to display the conventional advertisements as they are.

### SUMMARY OF THE INVENTION

It is therefore an object of the present invention to provide an advertisement providing system and an advertising providing method capable of assuring to provide an advertisement even on a user terminal having a low resolution and a small display area. It should be noted that in this Specification, an advertisement made from an image (including characters) will be referred to as an image advertisement and an advertisement made from a sound including voice will be referred to as a sound advertisement.

The advertisement providing system includes a service providing site and a user terminal connected via a communication network. The service providing site has a sound advertisement transmitter for transmitting to the user terminal a sound advertisement data convertible into a sound signal. The user terminal has a sound advertisement receiver for receiving the sound advertisement data transmitted from the service providing site, and a sound advertisement output unit for converting the sound advertisement data received by the sound advertisement receiver, into a sound signal and outputting the sound signal.

The service providing site transmits a sound advertisement data convertible into a sound signal, via a communication network to a user terminal. The user terminal receives the sound advertisement data transmitted from the service providing site and converts the sound advertisement data into a sound signal to be output. Thus, by using a sound advertisement instead of an image advertisement, it is possible to assure an advertisement even on a user terminal having a low resolution and a small display.

According to another aspect of the present invention, the user terminal further includes an acknowledgement signal transmitter for transmitting an advertisement output acknowledgement signal to the service providing site after output of the sound signal from the sound advertisement output unit, and the service providing site further includes an acknowledgement signal receiver for receiving the advertisement output acknowledgement signal transmitted from the user terminal, and a service starter for starting to provide the service after the advertisement output acknowledgement signal is received by the acknowledgement signal receiver.

The service providing site transmits a sound advertisement data convertible into a sound signal, to the user terminal. The user terminal receives a sound advertisement data transmitted from the service providing site, converts the sound advertisement data into a sound signal to be output, and transmits an advertisement output acknowledgement signal to the service providing site. The service providing site receives the advertisement output acknowledgement signal transmitted from the user terminal and starts to provide a service. Thus, the service providing site can confirm that the sound advertisement has been output at the user terminal. Accordingly, there is no case that the service is provided from the service providing site without outputting the sound advertisement at the user terminal.

According to still another aspect of the present invention, the user terminal is a mobile telephone set and the communication network is the Internet.

Recently, mobile telephone sets and the Internet are widely spread. On the other hand, a mobile telephone set should be small in size and light in weight as the absolute conditions. Accordingly, its display is small in size. The present invention can be applied to such a mobile telephone set and the Internet so as to surely provide an advertisement as a compensation for a service.

The advertisement providing method according to the present invention has a function equivalent to the aforementioned advertisement system.

The advertisement providing system and the advertisement providing method according to the present invention will be detailed in other words.

The present invention relates to a business model in which a service providing company providing a service via a communication network gets an advertisement fee from a sponsor by providing a sound advertisement to a user before providing a service.

The advertisement providing system according to the present invention includes a user terminal, a service providing site, and a communication network such as the Internet to connect them.

The user terminal has a function to reproduce a sound data and a function to connect to a communication network such as the Internet and may be, for example, a mobile telephone set, a portable information apparatus, a personal computer, and the like. More specifically, the user terminal has functions as follows: (1) a function to reproduce a sound advertisement data convertible to a sound and transmitted via the communication network from the service providing site, (2) a function to request for and utilize a service provided on the communication network by the service providing site, and (3) a function to connect to the communication network through a wire connection or a wireless connection.

The service providing site is realized in a host computer such as a server and provides a service on the communication network. That is, the service providing site is managed by a service provider. The managing cost is covered by the advertisement fee from the sponsor. The service provider and the advertisement sponsor may be different or the same. The service providing site has functions as follows: (1) a function, upon reception of a service utilizing request from a user terminal, to transmit to the user terminal via the communication network an advertisement by the sponsor in a data format convertible to a sound signal before providing a service and (2) a function to confirm that the sound advertisement has been output from the user terminal before making the service requested by the user, usable from the user terminal, and start the service.

### BRIEF DESCRIPTION OF THE DRAWINGS

FIG. 1 is a functional block diagram showing an advertisement providing system according to an embodiment of the present invention.

FIG. 2 is a flowchart showing an operation example of the advertisement providing system of FIG. 1: FIG. 2 [A] shows an operation at a mobile telephone set and FIG. 2 [B] shows an operation at a service providing site.

FIG. 3 is a front view of a mobile telephone set having a loud speaker from which a sound advertisement is reproduced in the advertisement providing system of FIG. 1.

FIG. 4 is a front view of a display screen of a mobile telephone set showing an example displayed in the advertisement providing system of FIG. 1.

### DESCRIPTION OF THE PREFERRED EMBODIMENTS

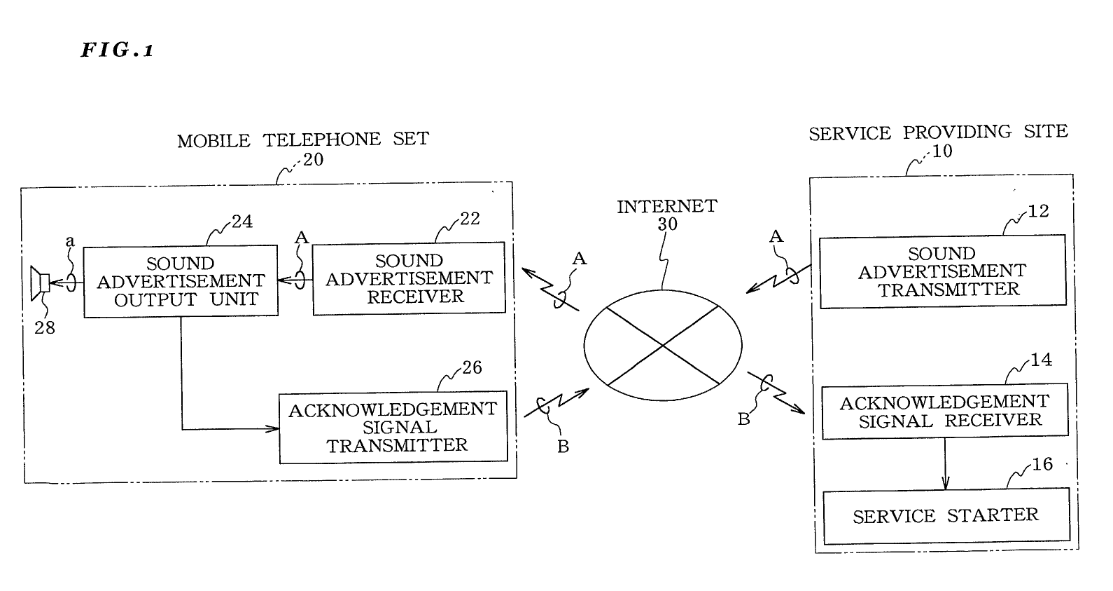

FIG. 1 is a functional block diagram showing an advertisement providing system according to an embodiment of the present invention. Hereinafter, explanation will be given with reference to FIG. 1.

The advertisement providing system according to the embodiment includes a service providing site 10 and a mobile telephone set 20 as a user terminal which are connected via the Internet 30 as a communication network.

The service providing site 10 includes a sound advertisement transmitter 12 for transmitting a sound advertisement data A convertible into a sound signal “a” to the mobile telephone set 20, an acknowledgement signal receiver 14 for receiving the advertisement output acknowledgement signal B transmitted from the mobile telephone set 20, and a serve providing starter 16 for starting to provide a serve upon reception of the advertisement output acknowledgement signal B by the acknowledgement signal receiver 14. The sound advertisement transmitter 12, the acknowledgement signal receiver 14, and the service providing starter 16 are realized, for example, as a server (host computer owned by a provider) and its program.

The mobile telephone set 20 includes: a sound advertisement receiver 22 for receiving a sound advertisement data A transmitted from the service providing site 10; a sound advertisement output unit 24 for converting the sound advertisement data A received by the sound advertisement receiver 22, into a sound signal “a” so as to be output; and an acknowledgement signal transmitter 26 for transmitting an advertisement output acknowledge signal B to the service providing site 10 after the sound signal a is output from the sound advertisement output unit 24. The sound advertisement receiver 22, the sound advertisement output unit 24, and the acknowledgement signal transmitter 26 is realized, for example, by a microcomputer and its program built in the mobile telephone set 20. Moreover, the mobile telephone set 20 includes a loud speaker 28 for converting an electric sound signal a into a sound (sound wave).

The service providing site 10 transmits a sound advertisement data A convertible into the sound signal a, to the mobile telephone set 20. The mobile telephone set 20 receives the sound advertisement data A transmitted from the service providing site 10, converts the sound advertisement data A into a sound signal a to be output and transmits an advertisement acknowledgement signal B to the service providing site 10. The service providing site 10 receives the advertisement output acknowledgement signal B transmitted from the mobile telephone set 20 and starts to provide a service to the user of this mobile phone. Thus, by using a sound advertisement instead of an image advertisement, it is possible to assure to provide an advertisement even on the mobile telephone set having a low resolution and a small display. Moreover, the service providing can be started only after acknowledgement that the sound advertisement has been output on the mobile telephone set 20. Accordingly, there is no case of starting the service form the service providing site 10 to the user of the mobile telephone set 20 without outputting the sound advertisement on the mobile telephone set 20.

The advertisement providing system according to the present invention will be detailed below.

A user, by utilizing his/her mobile telephone set 20, transmits a service utilization request to the service providing site 10 via the Internet 30. Upon reception of the service utilizing request from the user, the service providing site 10 transmits, as data convertible into sound, an advertisement of a sponsor who has made a contract with the service providing site 10, via the Internet 30 to the mobile telephone 20. The user utilizing the mobile telephone set 20 reproduces the data received from the service providing site 10 as a sound and hears the advertisement of the sponsor of the service providing site. Upon completion of the transmission of the advertisement of the sponsor, the service providing site 10 provides the service requested by the user, via the Internet to the user. That is, the user hears the sound (voice) of the advertisement of the sponsor from the mobile telephone set 20 before utilizing the service requested via the Internet 30.

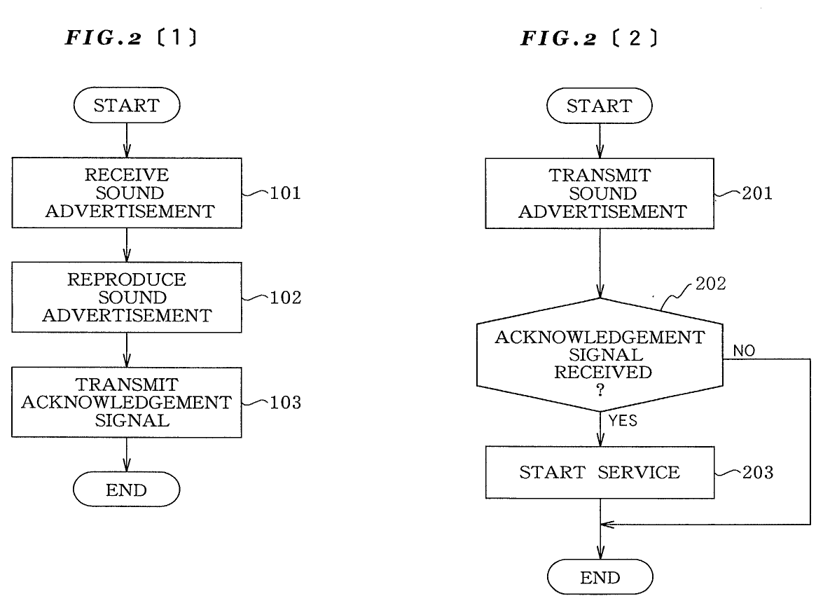

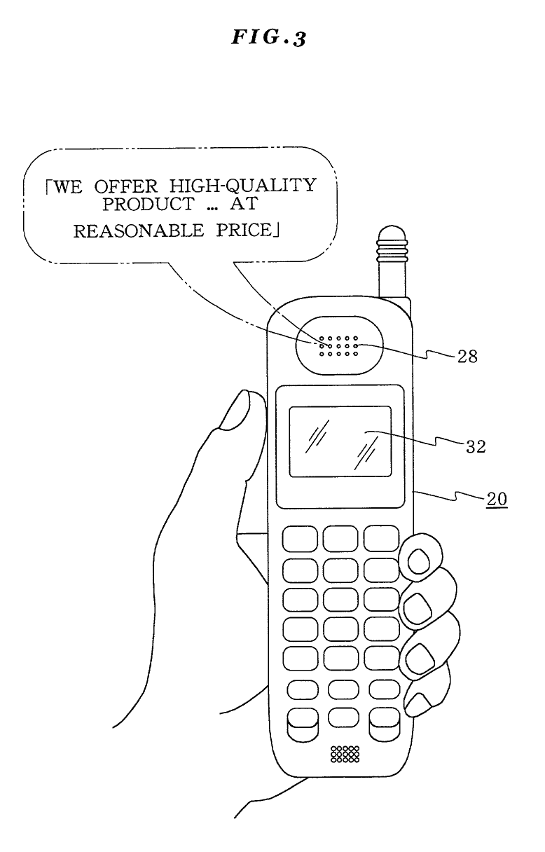

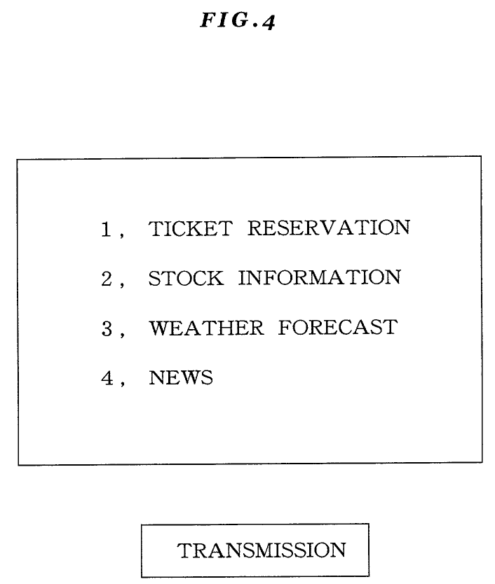

FIG. 2 is a flowchart showing an operation example in the advertising providing system of FIG. 1, FIG. 2 [A] shows an operation at the mobile telephone set and FIG. 2 [B] shows an operation at the service providing site. FIG. 3 is a front view of the mobile telephone set having a loud speaker providing a sound advertisement. FIG. 4 is a front view of a display screen of the mobile telephone set. Hereinafter, with reference to FIG. 1 to FIG. 4, operation of the advertisement providing system according to the present embodiment will be detailed.

Firstly, the user makes an access via the mobile telephone set 20 to a home page for providing service opened on the Internet 30 by the service providing site 10. This starts an operation of the advertisement providing system of the present embodiment. The service providing site 10, in response to this access, i.e., to the service utilization request, transmits the advertisement of the sponsor in a data format convertible into a sound, to the mobile telephone set 20 (step 201).

The mobile telephone set 20 receives the sound advertisement data transmitted from the service providing site 10 (step 101), converts the data into a sound, and reproduces it in the loud speaker 28 (step 102). Thus, the user hears the advertisement of the sponsor of the service providing site 10 via the mobile telephone set 20 such as “We provide a high-quality product A at a reasonable price”. When reproduction of the sound advertisement transmitted from the service providing site 10 is complete on the mobile telephone set 20, the mobile telephone set 20 reports the completion of the reproduction of the advertisement (acknowledgement signal) via the Internet 30 to the service providing site 10 (step 103).

The service providing site 10, in response to this signal, transmits a service menu for selecting a service, to a corresponding mobile telephone set 20 (steps 202 and 203). On the other hand, when the acknowledgement signal cannot be received because of some reason, no service is provided to that mobile telephone set (step 202). This terminates the operation as the advertisement providing system of the present embodiment.

Next, the user selects a service from a service menu displayed on a display 32 (FIG. 3) of the mobile telephone set 20 as shown in FIG. 4 and presses a transmission button shown in FIG. 4 so as to transmit a request for receiving a particular service. The service providing site 10, in response to this, executes the service requested by the user.

It should be noted that according to another aspect of the present invention, it is possible to omit the acknowledgement signal transmitter 26, the acknowledgement signal receiver 14, and the service providing starter 16.

The advertisement providing system and the advertising providing method according to the present invention utilizes a sound advertisement instead of an image advertisement for transmitting an advertisement from a service providing site to a user terminal and accordingly, can assure to provide the advertisement even on a user terminal having a low resolution and a small display.

In other words, the present invention has a effect to increase the number of users who effectively receive an advertisement arranged in a serviced, which in turn increases an advertisement fee as an income for a company running the site providing the service. This is because by providing a sound advertisement, it is possible to effectively deliver the advertisement even to a user terminal not having a display of a high resolution. Another effect is that it is possible to increase the effect of the advertisement because the advertisement can easily be brought into a user's attention. That is, a user's attention can be attracted by a sound advertisement even on a user terminal having a limited user interface operation aspect without performing a special operation.

According to the advertisement providing system and the advertisement providing method according to the present invention, a service providing site can check whether a sound advertisement is output at a user terminal and accordingly it is possible to prevent starting a service from the service providing site without output of the sound advertisement at the user terminal. In other words, the service site causes the user to hear the advertisement prior to getting the service, thereby assuring to attract user's attention.

According to another aspect of the present invention, the user terminal is a mobile telephone set and a communication network is the Internet. The mobile telephone set has a display having a low resolution and accordingly, an image advertisement cannot be used effectively but a sound advertisement can fully exhibit its effect.

The invention may be embodied in other specific forms without departing from the spirit or essential characteristic thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2000-096711 (Filed on Mar. 31, 2000) including specification, claims, drawings and summary are incorporated herein by reference in its entirety.

What is claimed is:

1. An advertisement providing system including a service providing site and a user terminal connected via a communication network, wherein
the service providing site has a sound advertisement transmitter for transmitting to the user terminal a sound advertisement data convertible into a sound signal, and the user terminal has a sound advertisement receiver for receiving the sound advertisement data transmitted from the service providing site, and a sound advertisement output unit for converting the sound advertisement data received by the sound advertisement receiver, into a sound signal and outputting the sound signal.

2. The advertisement providing system as claimed in claim 1, wherein
the user terminal further includes an acknowledgement signal transmitter for transmitting an advertisement output acknowledgement signal to the service providing site after output of the sound signal from the sound advertisement output unit, and
the service providing site further includes an acknowledgement signal receiver for receiving the advertisement output acknowledgement signal transmitted from the user terminal, and a service starter for starting to provide the service after the advertisement output acknowledgement signal is received by the acknowledgement signal receiver.

3. The advertisement providing system as claimed in claim 1, wherein the user terminal is a mobile telephone set and the communication network is the Internet.

4. The advertisement providing system as claimed in claim 2, wherein the user terminal is a mobile telephone set and the communication network is the Internet.

5. An advertisement providing method including a service providing site and a user terminal connected via a communication network, the method comprising:
a step of transmitting a sound advertisement data convertible into a sound signal, from the service providing site to the user terminal,
a step of receiving the sound advertisement data transmitted from the service providing site to the user terminal, and
a step of converting the sound advertisement data into a sound signal and outputting the signal.

6. The advertisement providing method as claimed in claim 4, wherein
the user terminal converts the sound advertisement data into a sound signal and then transmits an advertisement acknowledgement signal to the service providing site, and
the service providing site receives the advertisement output acknowledgement signal transmitted from the user terminal and then starts to provide a service.

7. The advertisement providing method as claimed in claim 5, wherein the user terminal is a mobile telephone set and the communication network is the Internet.

8. The advertisement providing method as claimed in claim 6, wherein the user terminal is a mobile telephone set and the communication network is the Internet.
